(19) United States
(12) Patent Application Publication
(10) Pub. No.: US 2022/0277633 A1
(43) Pub. Date: Sep. 1, 2022

(54) A METHOD AND SYSTEM FOR A CONNECTED FIRE DOORSET SYSTEM

(71) Applicant: INSURE FIRETEC LIMITED, Bury St Edmunds Suffolk (GB)

(72) Inventors: Glen HALL, Bury St Edmunds Suffolk (GB); Justin STAINES, Bury St Edmunds Suffolk (GB)

(21) Appl. No.: 17/618,192

(22) PCT Filed: Jun. 12, 2020
(86) PCT No.: PCT/GB2020/051422

§ 371 Date: Dec. 10, 2021

(30) Foreign Application Priority Data
Jun. 12, 2019 (GB) 1908454.0

(51) Int. Cl. G08B 17/06; E06B 7/28

(52) U.S. Cl. CPC G08B 17/06; E06B 7/28; G08C 17/02

(57) ABSTRACT

A retrofit unit is disclosed, adapted to be attached to a door as part of a door closer apparatus, the door closer apparatus being adapted to selectively prevent or facilitate movement of a door relative to its associated door frame, the retrofit unit comprising energy harvesting means adapted to convert energy harvested into electrical energy, the retrofit unit further having a first energy storage means, control means adapted to control the door closer unit, one or more sensors adapted to detect one or more environmental state, and a communication means adapted to transmit and receive information wirelessly to and from a remote base station and adapted to transmit and receive information wirelessly to and from a further retrofit unit. A door-integrated unit is also disclosed, as well as a fire safety system having a plurality of units and one or more base stations.

### FIELD OF THE INVENTION

The present inventive concept relates to fire safety systems, especially to the improved performance of fire doors and fire control and fire suppression systems.

### BACKGROUND TO THE INVENTION

Fire doors are usually required to be closed at all times unless being opened temporarily for use. Large buildings may have many fire doors. Furthermore, building users may find it convenient to open a fire door permanently or semi-permanently—despite the clear safety risks. Thus, large buildings or sites may be difficult to monitor and/or maintain.

Large buildings or sites also may comprise multiple fire “zones” for operating fire prevention and/or suppression apparatus. It is important that each zone is monitored so that action can be taken if needed in that zone. However, preferably action is not taken in zones where no action is needed. For example, activating sprinklers where not needed could cause damage to people and/or equipment.

Newly-built buildings often include suitable infrastructure to support a resilient monitoring, maintenance and sensor system. However, older buildings may not. Thus infrastructure limitations often reduce the ability to apply modern fire safety standards to older buildings. For example, the provision of suitable power supply may limit the number of devices an older building can support. Battery powered devices may be difficult to maintain on a wide scale because of the frequency of replacement needed.

Furthermore, there is a known difficulty with transmission of useful information relying on “backbone” communication network that may be disrupted in an emergency.

One proposal (CN107221122) is to send information via GPRS or local broadband connection. Neither technology is designed for low power situations and thus incompatible with lifetime of a fire door—which could be 10 years plus.

An alternative known proposal (WO2006040531) uses a master-slave door closer arrangement to send a central message to slave units in fire doors. Such a central signal could be sent sonically via an alarm sound. This system lacks redundancy and due to information being passed only one way, no information on fire location etc. can be passed from a doorset to a master or central unit. Furthermore, such an arrangement gives rise to a potential single point of failure. If the sonic alarm fails to sound then door closers would not activate.

Many currently available arrangements require batteries to be changed every 1 or 2 years.

### SUMMARY OF INVENTION

A first aspect of the present inventive concept provides a retrofit unit adapted to be attached to a door as part of a door closer apparatus, the door closer apparatus being adapted to selectively prevent or facilitate movement of a door relative to its associated door frame, the retrofit unit comprising energy harvesting means adapted to convert energy harvested into electrical energy, the retrofit unit further having a first energy storage means, control means adapted to control the door closer unit, one or more sensors adapted to detect one or more environmental state, and a communication means adapted to transmit and receive information wirelessly to and from a remote base station and adapted to transmit and receive information wirelessly to and from a further retrofit unit.

The retrofit unit may comprise an actuator adapted to prevent or facilitate movement of the door relative to its associated door frame. Thus the control means can control whether the door and door frame are able to move relative to one another. The actuator may be part of the door closer apparatus or external to it.

Usually a fire door arrangement comprises biasing means so that in the absence of a force preventing closure, the said door will close automatically.

The actuator is thus adapted to selectively maintain a door in an open state or allow its closure by biasing means.

Furthermore, such a biasing means is in effect a store of potential energy. When a user of a door opens the door they convert kinetic energy into potential energy. When the door closer allows the door to close, the biasing means converts that potential energy back into kinetic energy to move the door to a closed state.

The energy harvesting means may be adapted to convert some of the kinetic energy to electrical energy.

The energy harvesting means may comprise an electromechanical transducer. Such a transducer may be a generator or dynamo or the like to convert mechanical kinetic energy into electrical energy.

The energy harvesting means may comprise a piezoelectric transducer. For example, a piezoelectric transducer may be adapted to convert vibration into electrical energy. The energy harvesting means may be adapted to convert radio frequency electromagnetic radiation into electrical energy.

A vibration energy harvesting means may comprise a tip mass. The tip mas may be adjusted either manually or automatically based on the mechanical harmonic frequency of the vibrations.

Vibrational energy that is in resonance with the mechanical movement of the door is thus harvested using a piezoelectric device. The weight of a tip mass in the mechanical energy harvester creates the specific resonant frequency. Resonance describes the phenomenon of increased amplitude that occurs when the frequency of a periodically applied force (or a Fourier component of it) is equal or close to a natural frequency of the system on which it acts.

The energy harvesting means may comprise a electromagnetic induction transducer. Such an arrangement takes advantage of Maxwell's law of induction, to harvest energy by providing coils embedded in stationary and moving parts of the apparatus.

The energy harvesting means may be adapted to convert solar radiation into electrical energy. For example, the energy harvesting means may comprise a photovoltaic cell or a plurality of photo diodes.

The energy harvesting means may be adapted to convert ambient heat into electrical energy. This may be by way of using the Peltier effect.

The energy harvesting means may be adapted to comprise more than one of the aforementioned adaptations.

The first energy storage means may comprise a battery. The first energy storage means may comprise a capacitor. The capacitor may be a super capacitor. The first energy storage means may comprise a battery and a capacitor.

The first energy storage means may be coated in a high heat resistant sacrificial aluminium coating to IP9356. This allows for continuous operation up to 700 degrees Celsius and to maintain power to the communications apparatus during a fire.

Preferably there is a secondary energy storage means adapted to receive electrical energy from the first energy storage means. Thus the first energy storage means may be adapted to trickle charge the secondary energy storage means. Preferably the control means and components connected thereto are primarily powered by the secondary storage means. The secondary storage means may be a battery.

Preferably, the secondary storage means is a battery with a working life of at least five years. Preferably the secondary storage means can be replaced by a suitably skilled operative.

Alternatively the secondary storage means is a super capacitor. The super capacitor may be coated in a high heat resistant sacrificial aluminium coating to IP9356 as described above. The secondary storage means may comprise an accumulator. The secondary storage means may comprise a boost converter. Thus, energy harvested can trickle charge the secondary storage means. As little as 30 mV may be sufficient to provide trickle charging from, for example, a piezoelectric vibration energy harvesting means.

Preferably, the control means is adapted to communicate with the one or more sensors and the communication means.

Preferably, the control means is adapted to provide information signals via the communication means to the remote base station (whether directly or via the aforementioned peer to peer network). Thus, information from the one or more sensors can be transmitted to a remote data processing unit.

The control means may comprise a substantially integral data processing unit.

The one or more sensors may be selected from a fire detector, temperature sensor, smoke sensor and a door state sensor.

The provision of one or more sensors and a communication means adapted to transmit and receive information wirelessly enables the unit to provide information on the state of the local environment to a suitable data processing unit. Thus, not only is the retrofit unit capable of facilitating a door being closed on receipt of a suitable signal, the unit can provide information to a data processing unit which might in turn provide a suitable signal to facilitate door closure. This is advantageous because in a situation where retrofit units are provided for door closers to multiple doors in different locations, each door closer can be controlled individually based on information about the specific location. In other words, a building can potentially be divided into “zones” treated for the purposes of evacuation, suppression etc. based on local conditions rather than a single treatment being applied to the whole building.

The control means may be adapted to process signals from one or more sensors. Thus, signals from one or more sensors may be interpreted within the retrofit unit. For example, signals from a temperature sensor may be processed to interpret whether a fire is in progress. In a further example, signals from a force sensor may be processed to interpret whether a door close event has occurred. The control means may be adapted to process a signal from the energy harvesting means. Thus the control means can use signals from a force sensor and the energy harvesting means to determine whether a door close event has occurred. For example if a certain force sensor signal has been received and the energy harvesting means has been active that would suggest a door close event has occurred. However, if only one of those two signals is received then it is likely that a door close event has not occurred.

Signal processing of this kind could be used to identify faults or malicious behaviour etc.

Further sensors could be provided such as an energy storage means sensor adapted to measure the charge and/or health of an energy storage means.

The control means may be adapted to effect self-diagnostics. This can provide means for monitoring the reliability of the retrofit unit.

The provision of a communication means adapted to transmit and receive information wirelessly to and from a remote base station and adapted to transmit and receive information wirelessly to and from a further unit enables information to pass directly to a base station and also via another unit. Thus, if information transmission and/or receipt to or from the base station is impaired then that information may still be passed nonetheless via another unit. This provides a degree of redundancy and therefore resilience in information transmission. In an emergency situation such as a fire, this can be useful and even life-saving.

The communication means may be adapted to transmit and receive signals by way of the 868 MHz ISM (Industrial, Scientific, Medical) band or 433 MHz unlicensed band. Alternatively the communication means may be adapted to transmit and receive signals by way of a cellular telephone network.

The communication means may be adapted to transmit information directly to a fire authority.

Thus a plurality of units of the present inventive concept can form a peer-to-peer communications network.

A peer-to-peer communications network is sometimes referred to as a mesh network.

Such a peer-to-peer communications network formed by a plurality of units can provide a degree of redundancy, preferably an N+1 redundancy. The communication means may be adapted to comprise an astable switching circuit. This enables N+1 redundancy and provides compliance with fire safety regulations.

Relevant information also could be used to initiate maintenance of the door to which the retrofit unit is attached. For example, if a door state sensor reported that the relevant door has been open continuously for a certain period that may indicate that the door is defective or has been kept open artificially, unsafely. Thus an inspection might be triggered by an operative.

Preferably, the control means is adapted to operate in a passive mode while a trigger signal is not received. Thus, the retrofit unit may be adapted to draw very little electrical energy. For example, in passive mode the retrofit unit may draw current in the order of nanoamps.

A trigger signal may include a signal from a sensor. For example, the fire sensor may initiate a trigger signal which in turn would switch the control means out of its passive mode.

The retrofit unit may further comprise an illumination device. The illumination device is controlled by the control unit. The illumination device may be a light emitting diode, a matrix display or a cathode ray tube.

A suitable fire sensor may comprise a temperature measuring means and a time measuring means and a data processing means. Temperature is measured at pre-determined intervals and temperature data is passed to the said data processing means. If a change in temperature according to a pre-determined rate or pattern is detected then a signal can be send to the control means.

The retrofit unit may comprise a force sensor. When the door is opened this force is recorded by the force sensor. Likewise when the door is closed this force is recorded by the force sensor. This information can be passed to the control means for onward transmission to the remote data processing unit. Thus, the state of the relevant door can be monitored to ensure effective fire prevention. The force sensor may comprise an accelerometer. There may be a plurality of accelerometers to provide multiple axial (e.g. X, Y, Z) velocity and acceleration data in real time.

The retrofit unit may comprise a smoke sensor. Thus, if smoke is detected that information can be passed to the control means for onward transmission to the remote data processing unit.

The control means may be adapted to monitor the status of the control means and the connected sensors, energy storage means and other components. Thus, the retrofit unit can provide information on its operating status.

The retrofit unit may comprise information storage means. Information storage means may be provided within a sensor, for example by way of a non-volatile register of a sensor semiconductor. Storage of information in this way can provide additional redundancy and information security.

The control means may be adapted to determine which radio channels in the available radio bandwidth network are prone to noise. This information can be stored in a look-up table, or predicted by machine learning or by occasional seeking and re-tuning.

A door closer apparatus for a fire door typically comprises a plate or the like attached to a door panel and a main body attached to such a plate and the associated door frame.

The retrofit unit of the first aspect may be a module attached to the door to replace the aforementioned plate, and in turn attached to the aforementioned main body. Alternatively the retrofit unit may replace the main body itself.

When the retrofit unit replaces the main body itself, the retrofit unit may comprise a first element suitable for attachment to a plate and a second element suitable for attachment to a door frame, the first element and second element being moveable with respect to one another. The energy harvesting means may be adapted to convert energy from relative movement of the first and second elements into electrical energy.

The retrofit unit may comprise an integral biasing means adapted to facilitate closure of the said door. Alternatively, biasing means may be provided extrinsically.

The retrofit unit may comprise electrical connectors adapted to transfer electrical energy between the plate and the main body.

A second aspect of the present inventive concept provides a door-integrated unit being enclosed in an enclosure and having a power source comprising an energy storage means, a control means, one or more sensors adapted to detect one or more environmental state, and a communication means adapted to transmit and receive information wirelessly to and from a remote base station and adapted to transmit and receive information wirelessly to and from a further door-integrated unit.

The enclosure is preferably adapted to be affixed to and substantially enclosed by a portion of a door. For example, the enclosure may be adapted to fit into a hollow formed within the door. The arrangement may thus be similar to the way in which a deadlock mechanism is fitted within a door.

Preferably, the door-integrated unit is arranged in a portion of the door furthest from the door's hinges. This provides improved sensitivity to the door's position.

Preferably, the door-integrated unit is arranged in a portion of the door relatively near the top of the door in use. Locating the apparatus relatively reduces the likelihood of damage and lifts the one or more sensors above the ground.

Preferably, the one or more sensors are embedded within the door-integrated unit. In an alternative arrangement one or more sensors may be arranged outside the unit and connected thereto by appropriate means.

The second aspect may have one or more of the optional features or combinations thereof as described above in respect of the first aspect.

Preferably the power source has a working life of a minimum of 3 years.

Preferably, the door-integrated unit is adapted to be retrofitted to existing doors.

Alternatively, the door-integrated unit can be integrated into a door during manufacture.

A third aspect of the present inventive concept provides a fire safety system comprising a plurality of units and a base station, wherein the base station comprises a communication means adapted to transmit and receive information wirelessly to and from the or each unit and adapted to transmit and receive information to and from a remote data processing unit.

The term communications will be used in this description to refer to wireless communication between units and a base station as well as to wireless or wired communication between a base station and a remote data processing unit. Within the system more than one type of communications may be used. For example, communications between units and a base station may be of one type and communications between a base station and a remote data processing unit may be of another type.

The units may be as described above with respect to the first and second aspects, or a mixture of different units as so described.

The base station may further comprise an integral data processing unit. The integral data processing unit may be a micro-computer providing substantive computing processes in a relatively small physical footprint. One example of such a micro-computer is the Raspberry Pi®.

Each unit may be adapted to communicate directly with the base station and indirectly with the base station via a peer to peer network.

The system may have more than one base station. Thus, redundancy may be provided for a situation in which a primary base station is damaged or disconnected due to that situation.

If more than one base station is provided, each base station is adapted to communicate with all other base stations, where possible.

Each unit may be adapted to communicate directly with a primary pre-determined base station in preference to a subsequent base station. Thus, each unit may be adapted to fail over to a mode in which it communicates with a subsequent base station if it cannot communicate with a primary base station. The pre-determined base station and subsequent base station may not be the same for all units of the system.

Preferably, the communications are based on a Long Range Lower Power protocol. A suitable protocol is LoRa. Wireless communications may be by way of the 868 MHz ISM (Industrial, Scientific, Medical) band or 433 MHz unlicensed band. Alternatively communications may be via a cellular telephone network.

The system may effect an internet of things (IoT) protocol, such as Narrowband IoT which is a Low Power Wide Area Network radio standard developed by 3GPP, or alternatives such as eMTC and EC-GSM-IoT).

Preferably, each unit is adapted to provide a two-way communications check signal and response even when in passive mode.

The communications may utilise encrypted packet information. Thus, high-level security encryption may be effected.

Each unit and the or each base station may be adapted to have a unique address or identifier. The unique address may be of the kind used in MAC address systems.

The or each base station may be adapted to store information about the system and the building(s) in which it is located. Such information is preferably stored in encrypted form and with fully tracked change control. Such information may include system parameters. Such information may be stored in non-volatile registers.

The or each base station may be adapted to provide configurable notifications. Such notifications may include system status, unit status, device failure alert, fire alert, maintenance alert.

The or each base station may be mains powered. The or each base station is preferably provided with a battery backup.

The or each base station may be adapted to be removable from the system. Thus, during an emergency such as a fire a base station may be removed from the building in which it is located to a safe location.

The or each base station may be adapted to be encased in ruggedized material.

The or each base station may comprise a display and be adapted to provide on the display real time information about the system. Preferably the real time information includes unit status information, building schematic information, event information, mapping of event information.

The or each base station may be adapted to retrofit to existing installations.

The system may be provided with a machine learning protocol. The machine learning may typically be performed in a plurality of stages:

1. Data cleansing

2. Predictive analysis

3. Results verification.

Data cleansing is a process by which data samples and grouped into sets for statistical analysis. Said set may be, but not limited to, 10 to 100 samples. A plurality of tests on said data may determine common data set features, such as spikes, mean, median, oscillations, spread of results. The collective results of said analysis can provide a measure of the data set's stability and suitability for predictive analysis. To proceed to the next stage, a confidence of at least 80% is required.

Predictive analysis is the process of determining in an alert event is imminent. Typically, but not limited to, by linear regression or polynomial regression. Data sets provide the means of providing points on a curve. Said curve is the prediction of a future event. For the prediction of a slow burning fire, the gradient is the temperature change rate. For the detection and prediction of a failing door closure mechanism, a plurality of progression curves of limited range respective to each curve is a requirement. Predictive analysis is the means of determining a plurality of thresholds for an event to alert for.

Results verification is the process by which a confidence measure is applied to the predictive analysis. Said confidence is required to determine if the predictive analysis is correct, or likely to be correct. Results verification can be, but not limited to, if future data results are within a tolerance of typically less than 20% of the predictive analysis curve, within the limit of where the curve's gradient is high to resulting in a large resultant for a low data set range. Results verification is also measured from the system's ability to measure parameters. Said ability being measured by the data cleansing process and battery level as examples.

An exemplary arrangement of the present inventive concept may have one or more retrofit units or door-integrated unit located within a building. On the outset of an event a retrofit unit or door-integrated unit will transmit a wireless radio signal to be received by a base station. The base station will then transmit the signal of the event to a remote data processing unit of a service centre. The information received by the service centre will include information relating to the location and type of event reported by the door closer or door-integrated unit. For example, the information can include the state(s) of fire, temperature, smoke and door status sensors where appropriate.

### DETAILED DESCRIPTION OF THE INVENTION

Exemplary embodiments of aspects of the present inventive concept will now be described in further detail with reference to the accompanying drawings, in which:

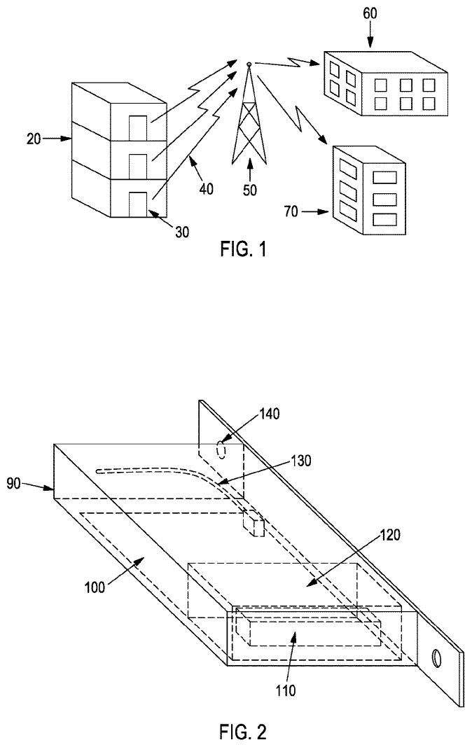

FIG. 1 shows an embodiment of a system effecting the inventive concept;

FIG. 2 shows a retrofit unit effecting the inventive concept (especially the first aspect);

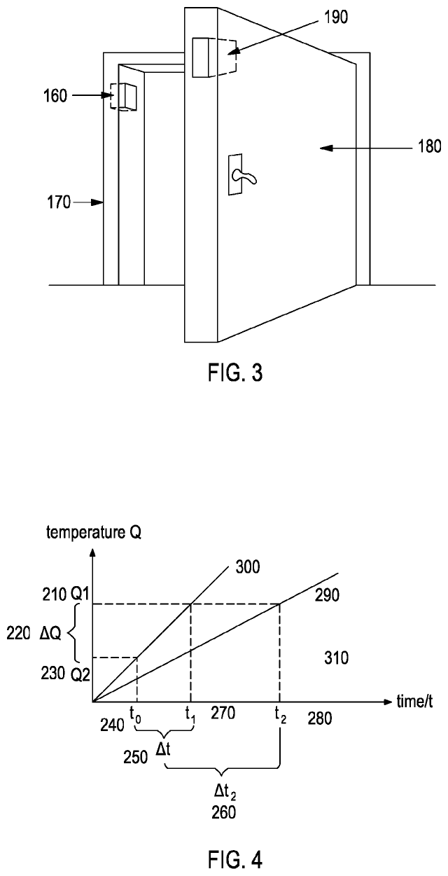

FIG. 3 shows a door-integrated unit effecting the inventive concept (especially the second aspect);

FIG. 4 shows an example of a temperature change over time which might be reported by a temperature sensor;

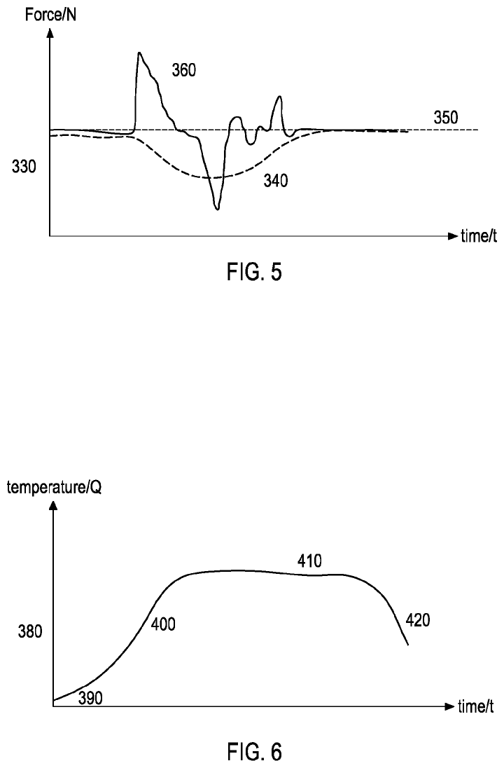

FIG. 5 shows an example of a force over time which might be reported by a force sensor;

FIG. 6 shows an example of a typical temperature variation over time in a room where a fire breaks out;

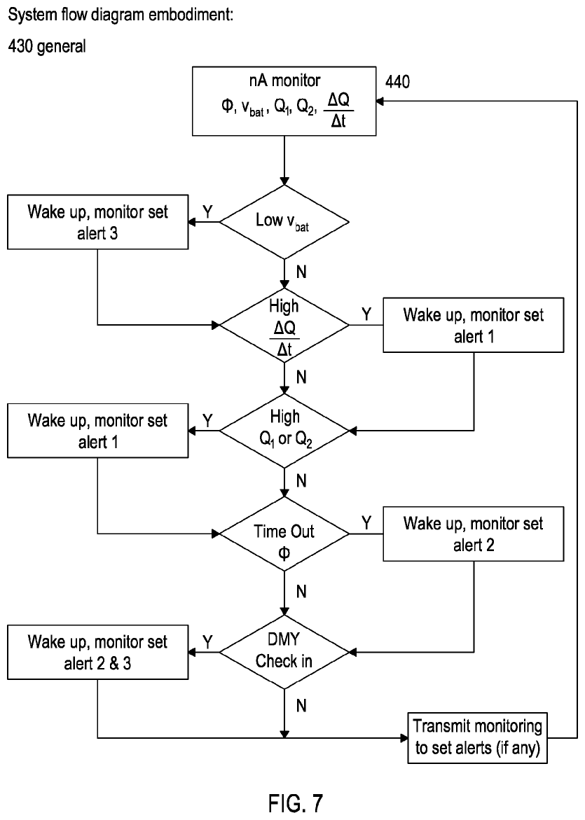

FIG. 7 shows a flow chart with an exemplary process of operation of a retrofit unit or door-integrated unit embodying the present inventive concept;

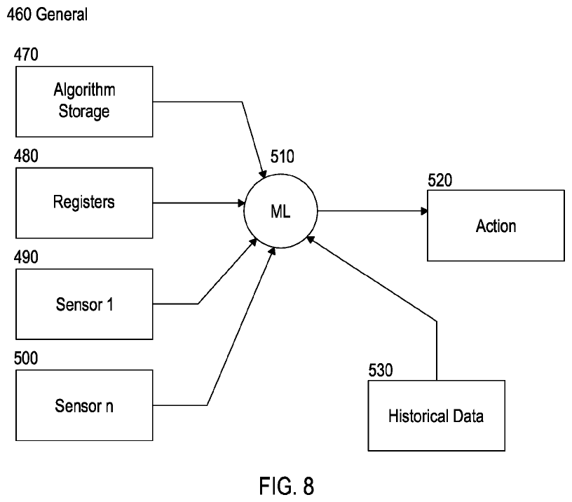

FIG. 8 further exemplifies the machine learning aspect described;

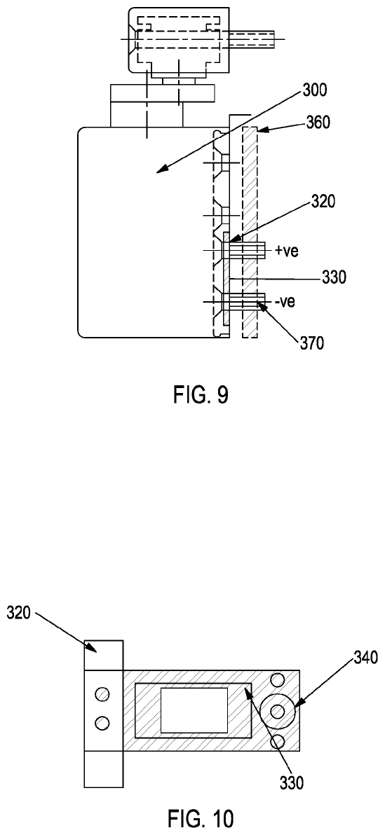

FIG. 9 shows a side elevation of a retrofit unit embodying the present inventive concept (especially the first aspect);

FIG. 10 shows an exemplary energy harvesting means;

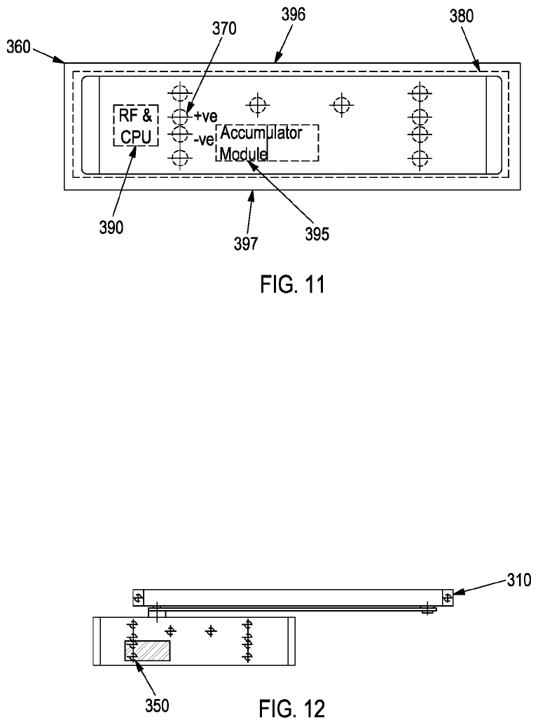

FIG. 11 shows another side elevation of a retrofit unit embodying the present inventive concept (especially the first aspect); and

FIG. 12 shows a front elevation of a door closer unit including a retrofit unit embodying the present inventive concept.

Turning to FIG. 1, a building 20 is shown in which a system embodying the present inventive concept is arranged. A retrofit unit 30 is located within the building 20. At the outset of an event the retrofit unit 30 is triggered by a signal from a sensor (not shown). The retrofit unit 30 transmits a radio signal 40 to base station 50. In turn the base station 50 can communicate to a service centre 60 or 70. The information received by the service centre(s) 60, 70 will shown the location and type of event reported by the retrofit unit 30. That information can include detection of fire or smoke, for example, and the location of the retrofit unit (and any zone information).

FIG. 2 shows an enclosure 90 for a door-integrated unit. The enclosure 90 is in this example constructed from fire retardant material. The enclosure contains the electronic elements 100 of the door-integrated unit. Also within the enclosure 90 is a battery 110 which is encase in an explosion proof enclosure 120 to prevent damage or injury during a fire event. Also shown are an antenna 130 to transmit and receive wireless signals from the door-integrated unit. The antenna 130 is encased within the enclosure 90 for protection thereof. The enclosure can be attached to a door by way of fixture points 140.

FIG. 3 shows a door 180 in which a door-integrated unit 190 has been fitted. This example shows the door-integrated unit 190 fitted to the outer edge of the door to improve sensitivity. A sensor 160 is shown inset within an accompanying door frame 170 and discrete from the door-integrated unit 190. Alternatively a sensor could be formed integrally with the door-integrated unit. The sensor 160 is arranged relatively high on the door frame 170, to reduce the likelihood of damage. Correspondingly, the door-integrated unit 190 is arranged relatively high on the door 180.

FIG. 4 shows possible temperature-time relationships 290, 300 which could be detected by a suitable temperature sensor of the present inventive concept. One of the functions of the present inventive concept is to detect a temperature rise in the event of a fire. A unit of the present inventive concept can monitor temperature over time. The temperature difference 220 along the temperature-time relationships 290 and 300 can allow an interpretation of whether a fire event has a higher burn rate as in relationship 300 or a slower burn rate as in relationship 290. A suitable signal or trigger can be sent as a notification, accordingly.

A fire door is generally only effective in the event of a fire if it is closed properly. One of the functions of the present inventive concept is to detect whether a fire door is closed. A unit of the present inventive concept can monitor force experienced against time, and this information can be interpreted to detect whether the respective door is closed properly. When a door is opened 360 this creates an event which can be recorded against time to determine a “usual” closing pattern 340 for that door, and with respect to the initial position 350. The unit can then report whether the door is closed properly or not. Improperly closed doors or those which are regularly not closed, for example, can be reported for maintenance so as to prevent the door being ineffective in the event of a fire.

FIG. 6 shows a typical temperature-time relationship in a room affected by a fire, or in other words a life cycle of a fire. The pattern of acceleration and life cycle of a fire is charted and shown from ignition 390 through growth 400 and full development 410 and then decay 420.

FIG. 7 shows a system flow diagram for an exemplary embodiment of the present inventive concept. A unit will transmit a signal prompted by an event shown 430 to a service centre monitoring the status of the unit. The unit will remain in passive mode 440 to preserve battery life unless an event occurs—as shown by the flow chart and leading to the transmission of an alert 450.

Turning to FIG. 8, the system may perform machine learning in a plurality of stages:

1. Data cleansing

2. Predictive analysis

3. Results verification

Data cleansing is the process by which data samples are grouped into sets for statistical analysis. Said set may be, but not limited to, 10 to 100 samples. A plurality of tests of said data set may determine common data set features, such as spikes, mean, median, oscillations, spread of results. The collective results of said analysis provides a measure of the data set's stability and suitability for predictive analysis. To proceed to the next stage, a confidence of at least 80% is required.

Predictive analysis is the process of determining if an alert event is imminent. Typically, but not limited to, by linear regression or polynomial regression. Data sets provide the means of providing points on a curve. Said curve is the predication of a future event. For the prediction of a slow burning fire, the gradient is a measure of how a given fire may develop. For the detection and prediction of a failing door closure mechanism, a plurality of progression curves of limited range respective to each curve is a requirement. Predictive analysis is the means of determining a plurality of thresholds of an event to alert for.

Results verification is the process by which a confidence measure is applied to the predictive analysis. Said confidence is required to determine if the predictive analysis is correct, or likely to be correct. Results verification can be, but not limited to, if future data results are within a tolerance of less than +/−20% if the predictive analysis curve, within the limit of where the curve's gradient is high to resulting in a large resultant for a low data set range. Results verification is also measured from the system's ability to measure parameters. Said ability being measured by the data cleansing process and battery level as examples.

In FIGS. 9 to 12 a door closer main body 300 is mounted vertically in parallel with a vibrational axis of a mechanical energy harvester 330. Clamp bar 320 also acts as a conductor of electrical energy through isolated conductive screws 370. Tip mass 340 is not clamped and is thus able to move in an air gap to allow movement of the mechanical energy harvester 330. Three photodiodes 396 in series can create 4.5 volts, 45 microamps as a dual redundant (N+1) power supply in case the energy harvester 330 fails. Radio frequency aerial 380 can be embedded in FR4 material of a PCT or as a separate loop antenna and can by used both for transmission and receiving with a peer to peer network (mesh network) of units and/or base stations. Furthermore, the aerial 380 can be used for harvesting radio frequency energy when not being used to transmit or receive a signal as such. Accumulator 395 is an arrangement of prismatic super capacitors in a dual redundancy (N+1) configuration. Cells are coated in a high heat resistant sacrificial aluminium coating to IP9356 standard, allowing operating temperatures up to 700 celcius. Tip mass 340 is selected for the harmonic frequency moment of door vibration. Sensors 397 may be thermal and/or carbon monoxide sensors. Also shown in FIG. 11 is a radio frequency radio and central processing unit, and an accumulator module.

1. A retrofit unit adapted to be attached to a door as part of a door closer apparatus, the door closer apparatus being adapted to selectively prevent or facilitate movement of a door relative to its associated door frame, the retrofit unit comprising an actuator adapted to prevent or facilitate movement of the door relative to its associated door frame, energy harvesting means adapted to convert energy harvested into electrical energy and comprising an electromechanical transducer adapted to convert kinetic energy of movement of the door to electrical energy, the retrofit unit further having a first energy storage means, control means adapted to control the door closer unit, one or more sensors adapted to detect one or more environmental state, and a communication means adapted to transmit and receive information wirelessly to and from a remote base station and adapted to transmit and receive information wirelessly to and from a further retrofit unit.

2. A retrofit unit according to claim 1, wherein the energy harvesting means further comprises a piezoelectric transducer.

3. A retrofit unit according to claim 1, wherein the energy harvesting means further comprises a electromagnetic induction transducer.

4. A retrofit unit according to claim 1, wherein the energy harvesting means is further adapted to convert radio frequency electromagnetic radiation into electrical energy.

5. A retrofit unit according to claim 1, wherein the energy harvesting means is further adapted to convert solar radiation into electrical energy.

6. A retrofit unit according to claim 1, wherein the energy harvesting means is further adapted to convert ambient heat into electrical energy.

7. A retrofit unit according claim 1, further comprising a secondary energy storage means adapted to receive electrical energy from the first energy storage means.

8. A retrofit unit according to claim 7, wherein the control means and components connected thereto are primarily powered by the secondary storage means.

9. A retrofit unit according to claim 1, wherein the control means is adapted to process a signal from the energy harvesting means.

10. A retrofit unit according to claim 1, wherein the unit is a module adapted to attach to the door to replace a plate, and is in turn adapted to attach to the aforementioned main body.

11. A retrofit unit according to claim 1, wherein the unit is adapted to replace the main body of the door closer itself.

12. A door-integrated unit being enclosed in an enclosure and having a power source comprising an energy storage means, a control means, one or more sensors adapted to detect one or more environmental state, and a communication means adapted to transmit and receive information wirelessly to and from a remote base station and adapted to transmit and receive information wirelessly to and from a further door-integrated unit.

13. A door-integrated unit according to claim 12, wherein the enclosure is adapted to be affixed to and substantially enclosed by a portion of a door.

14. A door-integrated unit according to claim 12, wherein the door-integrated apparatus is arranged in a portion of the door furthest from the door's hinges.

15. A door-integrated unit according to claim 12, wherein the door-integrated apparatus is arranged in a portion of the door relatively near the top of the door in use.

16. A door-integrated unit according to claim 12, wherein one or more sensors are embedded within the door-integrated apparatus.

17. A door-integrated unit according to claim 12, wherein one or more sensors are arranged outside but the apparatus and connected thereto by appropriate means.

18. A unit according to claim 1, wherein the control means is adapted to communicate with the one or more sensors and the communication means.

19. A unit according to claim 1, wherein the control means is adapted to provide information signals via the communication means to the remote base station.

20. A unit according to claim 1, wherein the control means comprises a substantially integral data processing unit.

21. A unit according to claim 1, wherein the one or more sensors may be selected from a fire detector, temperature sensor, smoke sensor, door state sensor, force sensor.

22. A unit according to claim 1, wherein the control means is adapted to process signals from one or more sensors.

23. A unit according to claim 1, wherein the control means is adapted to effect self-diagnostics.

24. A unit according to claim 1, wherein the control means is adapted to operate in a passive mode while a trigger signal is not received.

25. A unit according to claim 1, wherein the control means is adapted to monitor the status of the control means and the connected sensors, energy storage means and other components.

26. A unit according to claim 1, wherein the control means is adapted to determine which radio channels in the available radio bandwidth network are prone to noise.

27. A unit according to claim 1, wherein the unit is adapted to provide a two-way communications check signal and response even when the control means is in passive mode.

28. A plurality of units according to claim 1, forming a peer-to-peer communications network.

29. A fire safety system comprising a plurality of units each according to claim 1 and a base station, wherein the base station comprises a communication means adapted to transmit and receive information wirelessly to and from the or each unit and adapted to transmit and receive information to and from a remote data processing unit.

30. A fire safety system according to claim 29, wherein the base station further comprises an integral data processing unit.

31. A fire safety system according to claim 29, wherein each unit is adapted to communicate directly with the base station and indirectly with the base station via a peer to peer network.

32. A fire safety system according to claim 29, wherein the system has more than one base station.

33. A fire safety system according to claim 32, wherein each unit is adapted to communicate directly with a primary pre-determined base station in preference to a subsequent base station.

34. A fire safety system according to claim 29, wherein the or each base station is adapted to store information about the system and the building(s) in which it is located.

35. A fire safety system according to claim 29, wherein the or each base station is adapted to provide configurable notifications.
